(19) United States
(12) Patent Application Publication
(10) Pub. No.: US 2018/0127522 A1
(43) Pub. Date: May 10, 2018

(54) Short-Chain Polyethylene Homopolymers Having Improved Grindability

(71) Applicant: CLARIANT INTERNATIONAL LTD, Muttenz (CH)

(72) Inventors: Andreas LANG, Fürstenfeldbruck (DE); Hans-Friedrich HERRMANN, Gross-Gerau (DE); Gerd HOHNER, Augsburg (DE); Sebastijan BACH, Achsheim (DE); Rainer FELL, Gersthofen (DE)

(73) Assignee: CLARIANT PLASTICS & COATINGS LTD, Muttenz (CH)

(21) Appl. No.: 15/569,624

(22) PCT Filed: Apr. 26, 2016
(86) PCT No.: PCT/EP2016/059265

§ 371 Date: Oct. 26, 2017

(30) Foreign Application Priority Data
Apr. 29, 2015 (DE) 10 2015 005 413.9

(51) Int. Cl. C08F 110/02; C08F 4/6592; C08L 91/06; C09D 11/12; G03G 9/09; G03G 9/087; C09D 7/40

(52) U.S. Cl. CPC C08F 110/02; C08F 4/6592; C08L 91/06; C09D 11/12; C08F 2500/11; G03G 9/08782; C09D 7/69; C08F 2500/08; G03G 9/0906

(57) ABSTRACT

A polyethylene homopolymer having improved grindability, prepared with a metallocene catalyst system and is characterized by a melt viscosity of 5 to <60 mPa·s at 140° C. and a ram penetration hardness ranging from 210 to 500 bar, as measured according to DGF M-III 9e, and to use thereof as a component in toners, hot-melt adhesives or pigment master batches.

The present invention relates to short-chain polyethylene homopolymers having outstanding grindability and also to the use thereof.

Short-chain polyolefins, which can also be referred to as waxes, are important for a host of areas of application. There is increasing interest in applications for which the waxes are used in micronized form—for example, as an additive in printing inks and coating materials, as nucleating agents in expanded polystyrene, and as dispersants for pigments, for example. In printing inks, micronized waxes increase the abrasion, scuff and scratch resistance of printed products. In coating materials, micronized waxes serve not only to improve the mechanical properties of the film surface but also for achieving matting effects (cf. Ullmann's Encyclopedia of Industrial Chemistry, Weinheim, Basel, Cambridge, N.Y., 5^{th} ed., Vol. A28, page 103 ff). Micronization is accomplished by grinding on suitable mills, optionally with subsequent classification. The required average particle sizes are generally below 15 μm. Since the required mill technology necessitates a specific infrastructure and, consequently, a high technical and financial outlay, the throughput of the material to be micronized represents a considerable economic factor. Considered critical to the throughput when micronizing polyolefin waxes are the mutually correlating physical parameters of hardness, brittleness, crystallinity, density, and melt viscosity. These parameters are determined at a molecular level by degree of branching, isotacticity, saturation, chain length, and chain length distribution. Experience to date shows that the harder and more brittle the polyethylene waxes, the better suited they are to micronization by grinding. The melt viscosity has a part to play here insofar as the hardness levels drop in the range of low viscosities—below about 50 mPa·s at 140° C. To date it has therefore been obvious to use waxes of relatively high viscosity for grinding purposes.

Waxes used for the aforementioned applications include micronized polyethylene waxes from different kinds of production process. Customary, for example, are waxes obtained from radical polymerization at high pressures and temperatures. The broad distribution of the chain lengths, i.e., the polydispersity, and the nonlinear, branched structure of the resulting polyethylene lead to reduced hardness in the product. Moreover, waxes comprising thermally degraded polyethylene may be employed, but the process of degradation of linear polyethylene leads to partly branched and unsaturated polyethylene wax, which likewise exhibits reduced hardness. By polymerization using Ziegler-Natta catalysts, in other words with a titanium compound as catalytically active species, in solution it is possible to prepare linear, saturated polyethylene waxes of high hardness (cf. U.S. Pat. No. 3,951,935, U.S. Pat. No. 4,039,560). However, short-chain, i.e. waxlike, polyethylenes are achievable only with considerable detractions from the yield. Polymerization using metallocene catalyst systems, on the other hand, allows access to waxlike polyethylenes with high hardness which at the same time feature high yields in production.

It is known, furthermore, that polyolefin waxes can be given a polar modification by introduction of oxygen-containing groups, such as acid or anhydride functions. The purpose of the modification is that of adaptation to specific performance requirements. By means of such a measure, for example, it is possible to improve the affinity of the waxes for polar media, such as the dispersibility in water. Modification, starting from the nonpolar waxes, is accomplished for example by oxidation with air or by reaction with oxygen-containing monomers, for instance unsaturated carboxylic acids such as acrylic or methacrylic acid or maleic acid or derivatives of such acids such as esters or anhydrides. Corresponding prior art is found for example in EP 0890583 A1 or WO 1998023652.

European application text EP 0890619 describes polyethylene waxes produced using metallocene catalysts, and the use of said waxes in printing inks and coating materials. The waxes are used in forms including a ground form. With regard to their melt viscosity, the very broad range between 5 and 100 000 mPa·s, measured at 140° C., is claimed. The only stated inventive example of a PE homopolymer wax has a melt viscosity at 140° C. of 350 mPa·s.

Micronized PE waxes produced using metallocene catalysts are also known from EP 1261669. They are used as a dispersing aid for organic pigments. According to the claim, their melt viscosity is between 10 and 10 000 mPa·s at 140° C.; there is no data on the melt viscosity of the waxes used by way of example.

EP 1272575 describes the use of micronized polyethylene waxes in a mixture with further components as additives for printing inks. With regard to the melt viscosities of the waxes, a range between 10 and 10 000 mPa·s at 140° C. is stated; the relevant inventive example lies at 350 mPa·s.

In the prior art as stated above, no details are given regarding the grinding operation, and in particular there is no engagement with aspects relating to the economy or effectiveness of such a process, in the form of data on the throughput achieved or the like, for instance.

It is an object of the present invention to provide polyethylene waxes having improved grindability which at the same time can be used in existing applications without a loss of quality.

It has surprisingly been found that short-chain waxlike polyethylene homopolymers having improved grindability can be obtained if they are prepared by means of metallocene catalyst systems and fulfil certain requirements.

A subject of the invention are therefore short-chain waxlike polyethylene homopolymers having improved grindability, which are prepared by means of metallocene catalyst systems and have a melt viscosity at 140° C. in the range of 5 and <60 mPa·s, and also a ram penetration hardness as measured to DGF M-III 9e of 210 to 500 bar.

In one preferred embodiment of the invention, the polyethylene homopolymers of the invention are further characterized by
a dropping point of 113 to 128° C.,
a melting point of 100 to 123° C.,
a density of 0.93 to 0.97 g/cm³ at 25° C., and
a heat of fusion of 210 to 270 J/g.

The melt viscosity at 140° C. is situated more particularly in the range from 7 to 50 mPa·s, preferably in the range from 8 to 30 mPa·s, especially preferably from 9 to 14 mPa·s.

The melt viscosity here is determined according to DIN 53019 with a rotary viscometer as follows:

The wax melt under investigation is located in an annular gap between two coaxial cylinders, of which one rotates at a constant speed (rotor) while the other is at rest (stator). Determinations are made of the rotary speed and of the torque required to overcome the frictional resistance of the liquid in the annular gap. From the geometric dimensions of the system and also from the torque and speed values ascertained, it is possible to calculate the shear stress prevailing in the liquid, and the shear rate, and hence the viscosity.

The polyethylene homopolymers of the invention have a dropping point in the range from 113 to 128° C., preferably from 114 to 127° C., more preferably from 115 to 125° C., especially preferably from 115 to 122° C., a melting point in the range from 100 to 123° C., preferably from 110 to 122° C., more preferably from 112 to 121° C., a density at 25° C. in the range from 0.93 g/cm³ to 0.97 g/cm³, preferably from 0.94 g/cm³ to 0.97 g/cm³, more preferably from 0.95 g/cm³ to 0.97 g/cm³, a heat of fusion in the range from 210 J/g to 270 J/g, preferably from 220 J/g to 260 J/g, more preferably from 225 J/g to 250 J/g, and a ram penetration hardness of 210 bar to 500 bar, preferably from 220 bar to 480 bar, more preferably from 225 bar to 460 bar.

The dropping points are determined according to DIN 51801-2, the densities according to DIN EN ISO 1183-3. Melting points and heats of fusion are measured by means of differential thermoanalysis according to DIN EN ISO 11357-1 in the temperature range from −50 to 200° C. and at a heating rate of 10 K/min under nitrogen.

The ram penetration hardness is determined according to DGF M-III 9e (“Deutsche Einheitsmethoden zur Untersuchung von Fetten, Fettprodukten, Tensiden und verwandten Stoffen”, Deutsche Gesellschaft für Fettwissenschaft, 2^{nd} edition, 2014).

The present invention further relates to micronized waxes having an average particle size d₅₀ of ≤15 μm, comprising polyethylene homopolymers which have a melt viscosity of 5 to <60 mPa·s at 140° C.

In one particular embodiment, the polyethylene homopolymer wax of the invention takes the form of a micronized wax having an average particle size of ≤12 μm, more particularly of ≤10 μm.

The d₅₀ is determined according to ISO 13320-1.

In another embodiment, the polyethylene homopolymer has a polar modification and is characterized by an oxygen-containing group content. In this case it preferably has an acid number of between 0.5 and 100 mg KOH/g polymer. More preferably the acid number is between 15 and 60 mg KOH/g polymer. The acid number is determined according to ISO 2114.

The polyethylene waxes of the invention are prepared using metallocene compounds of the formula I as catalyst.

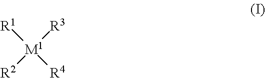

This formula also encompasses compounds of the formula Ia,

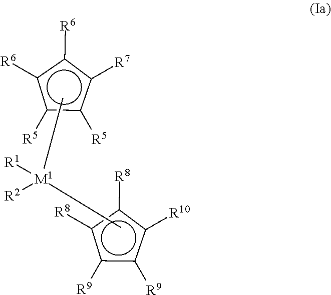

of the formula Ib,

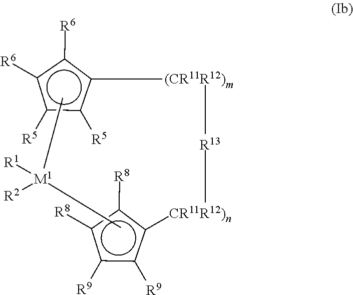

and of the formula Ic.

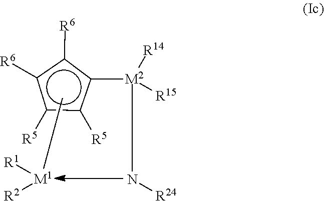

In the formulae I, Ia and Ib, M¹ is a metal from group IVb, Vb or VIb of the Periodic Table, as for example titanium, zirconium, hafnium, vanadium, niobium, tantalum, chromium, molybdenum, tungsten, preferably titanium, zirconium, hafnium.

R¹ and R² are identical or different and are a hydrogen atom, a C₁-C₁₀, preferably C₁-C₃ alkyl group, more particularly methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀, preferably C₇-C₁₀ arylalkyl group, a C₇-C₄₀, preferably C₇-C₁₂ alkylaryl group, a C₈-C₄₀, preferably C₈-C₁₂ arylalkenyl group, or a halogen, preferably chlorine atom.

R³ and R⁴ are identical or different and are a mono- or polycyclic hydrocarbon radical, which may form a sandwich structure with the central atom M¹. R³ and R⁴ are preferably cyclopentadienyl, indenyl, tetrahydroindenyl, benzoindenyl or fluorenyl, and the parent structures may also carry additional substituents or be bridged with one another. Moreover, one of the radicals R³ and R⁴ may be a substituted nitrogen atom, in which case R²⁴ has the definition of R¹⁷ and is preferably methyl, tert-butyl or cyclohexyl.

R⁵, R⁶, R⁷, R⁸, R⁹ and R¹⁰ are identical or different and are a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a —NR¹⁶₂, —SR¹⁶, —OSiR¹⁶₃, —SiR¹⁶₃ or —PR¹⁶₂ radical, in which R¹⁶ is a C₁-C₁₀, preferably C₁-C₃ alkyl group or C₆-C₁₀, preferably C₆-C₈ aryl group or else, in the case of radicals containing Si or P, a halogen atom, preferably chlorine atom, or two adjacent radicals R⁵, R⁶, R⁷, R⁸, R⁹ or R¹⁰ form a ring with the carbon atoms connecting them. Particularly preferred ligands are the substituted compounds of the parent structures cyclopentadienyl, indenyl, tetrahydroindenyl, benzoindenyl or fluorenyl.

R¹³ is

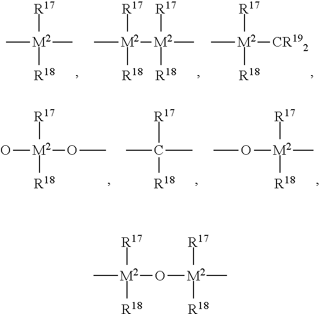

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are a hydrogen atom, a halogen atom, preferably a fluorine, chlorine or bromine atom, a C₁-C₃₀, preferably C₁-C₄ alkyl, more particularly methyl group, a C₁-C₁₀ fluoroalkyl, preferably CF₃ group, a C₆-C₁₀ fluoroaryl, preferably pentafluorophenyl group, a C₆-C₁₀, preferably C₆-C₈ aryl group, a C₁-C₁₀, preferably C₁-C₄ alkoxy, more particularly methoxy group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group or a C₇-C₄₀, preferably C₇-C₁₂ alkylaryl group, or R¹⁷ and R¹⁸ or R¹⁷ and R¹⁹ in each case form a ring together with the atoms connecting them.

M² is silicon, germanium or tin, preferably silicon and germanium. R¹³ is preferably ═CR¹⁷R¹⁸, ═SiR¹⁷R¹⁸, ═GeR¹⁷R¹⁸, —O—, —S—, SO, ═PR¹⁷ or ═P(O)R¹⁷.

R¹¹ and R¹² are identical or different and have the definition stated for R¹⁷. m and n are identical or different and are zero, 1 or 2, preferably zero or 1, and m plus n is zero, 1 or 2, preferably zero or 1.

R¹⁴ and R¹⁵ have the definition of R¹⁷ and R¹⁸.

Specific examples of suitable metallocenes are as follows:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconium dimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride,
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
   and also in each case the alkyl or aryl derivatives of these metallocene dichlorides.

The single-center catalyst systems are activated using suitable cocatalysts. Suitable cocatalysts for metallocenes of the formula (I) are organoaluminum compounds, especially aluminoxanes or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae, x is a number from 1 to 4, the radicals R²⁰ are identical or different, preferably identical, and are C₁-C₁₀ alkyl or C₆-C₁₈ aryl, or two radicals R²⁰ form a ring together with the atom connecting them, and the radicals R²¹ are identical or different, preferably identical, and are C₆-C₁₈ aryl which may be substituted by alkyl, haloalkyl or fluorine. In particular R²⁰ is ethyl, propyl, butyl or phenyl and R²¹ is phenyl, pentafluorophenyl, 3,5-bistrifluoromethylphenyl, mesityl, xylyl or tolyl.

Depending on process, supported metallocene catalysts may also be used.

The polymerization is carried out in solution, in suspension or in the gas phase, continuously or batchwise, in one or more stages. The temperature of the polymerization is between 0 and 200° C., preferably in the range from 70 to 150° C.

Possible processes for preparing the polyolefin waxes of the invention are described in EP-A-0 321 851 and EP-A-571 822. In principle however, suitable processes include all other processes which allow the use of metallocene or other single-center catalyst systems with the central atoms titanium, zirconium, hafnium, vanadium, niobium, tantalum, chromium, molybdenum or tungsten.

The total pressure in the polymerization system is 0.5 to 120 bar. Preference is given to polymerization in the pressure range from 5 to 64 bar that is of particular interest industrially.

In a known way, hydrogen is added to regulate the molar mass and/or the melt viscosity. The melt viscosity falls as the partial pressure of hydrogen goes up; this pressure is in the range from 0.05 to 50 bar, preferably 0.1 to 25 bar, more particularly 0.2 to 10 bar. Moreover, the melt viscosity may also be modified by adaptation to the polymerization temperature. With an increase in temperature, generally, lower melt viscosities are obtained.

Polymers with a broad distribution are obtainable by a multistage operation or by using mixtures of two or more catalysts.

The concentration of the transition metal component, based on the transition metal, is between 10⁻³ to 10⁻⁷, preferably 10⁻⁴ to 10⁻⁶ mol of transition metal per dm³ of solvent or per dm³ of reactor volume. The cocatalyst is in line with the activity for activation in a ratio preferably of up to 1:500, based on the transition metal. In principle, however, higher concentrations are also possible.

Serving as suspension medium or solvent are aliphatic, unbranched or branched, open-chain or cyclic hydrocarbons having at least 3 carbon atoms, such as, for example, propane, isobutane, n-butane, hexane, cyclohexane, heptane, octane, or diesel oils or aromatic hydrocarbons such as, for example, toluene, or low-boiling halogenated hydrocarbons, such as, for example, methylene chloride, and also mixtures thereof.

For the polymerization it is additionally possible, before adding the catalyst, to add another aluminum alkyl compound such as, for example, trimethylaluminum, triethylaluminum, triisobutylaluminum or isoprenylaluminum for the purpose of rendering the polymerization system inert, at a concentration of 1 to 0.001 mmol of Al per kg of reactor capacity. Furthermore, these compounds may also be used additionally to regulate the molar mass.

The polyethylene waxes of the invention are micronized conventionally by grinding and subsequently classifying the ground material. For the grinding operation, all suitable mill constructions may be used. Impact mills or jet mills are suitable, for example.

The waxes may also be ground jointly in a mixture with further components. Further components contemplated include PTFE, amide waxes, montan waxes, natural plant waxes such as carnauba wax, or derivatives of montan waxes or natural plant waxes, sorbitol esters, synthetic hydrocarbon waxes such as Fischer-Tropsch paraffins, or polyolefin waxes prepared not by means of metallocene catalysts, or micro- and macrocrystalline paraffins, polar polyolefin waxes, polyamides, and polyolefins. For more precise determination of these additional components, reference may here be made expressly to document EP 1272575. Also suitable for joint grinding with the polyethylene waxes of the invention, moreover, are glycosidic polymers, of the type described for example in document WO 2013/026530, examples being unmodified or modified starch. Where mixtures in powder form are to be produced, the high crystallinity of the polyethylene waxes of the invention makes for easy grindability of the mixture and prevents the clumping of the powders, of the kind regularly observed when using other low-melting waxes.

The polyethylene homopolymers of the invention can be employed advantageously in diverse fields of use. As components in toners, their low viscosity makes for ready miscibility in the course of toner production, and they can therefore be employed especially for use in black and color toners in photocopiers and laser printers. In a similar way, these waxes can be deployed advantageously in printing inks, in coating materials, as nucleating agents for expandable polystyrene, and as a component in hotmelt adhesives.

In all applications in which the waxes are processed in the liquid-melt state at elevated temperature, discoloration or crosslinking of the melt is prevented; for the user, consequently, there is no heat-induced alteration of the wax melt, even at high temperatures and over long service lives in processing machines. For this reason, the use of the polyethylene homopolymers of the invention as auxiliaries in plastics processing, as for example as lubricants, is very advantageous. Especially advantageous is their use in connection with the production of masterbatches, examples being pigment masterbatches or dye masterbatches for polymer coloring. The low viscosity of the polyethylene wax melts of the invention permits improved wetting and dispersing of the chromophores and thereby increases the color yield and intensity.

### EXAMPLES

### Preparation of Polyethylene Waxes

### Example 2 (not Inventive)

For the preparation of the catalyst, 6 mg of bis(indenyl)zirconium dichloride were dissolved in 20 cm³ of toluenic methylaluminoxane solution (corresponding to 27 mmol of Al) and reacted with the methylaluminoxane by being left to stand for 15 minutes. In parallel with this, a dry 16 dm³ vessel flushed with nitrogen was filled with 4 kg of propane and brought to a temperature of 70° C. At this temperature, 0.15 bar of hydrogen and 30 cm³ of the toluenic methylaluminoxane solution were added via a pressure lock and the mixture was stirred at 100 rpm. The pressure was topped up with ethylene to a total pressure of 31 bar, and the polymerization was initiated at 250 rpm by addition of the catalyst via the pressure lock. The polymerization temperature was regulated at 70° C. by cooling, and the total pressure was kept constant by further addition of ethylene. After a polymerization time of 1 hour, the reaction was stopped by addition of isopropanol and the reactor was let down and opened. The physical properties of the polyethylene wax obtained are reported in tab. 1.

### Examples 3, 4 and 9 (not Inventive) and Examples 5-8 (Inventive)

Preparation took place in a manner similar to that indicated for example 2. The melt viscosity was adjusted by gradually increasing the hydrogen concentration.

The inventive polyethylenes from examples 5-8 were ground on an AFG 100 fluidized-bed opposed-jet mill from Hosokawa Alpine. The classifier speed was 8000 revolutions per minute (rpm) and the grinding pressure was 6.0 bar. The parameter used for grindability was the throughput, measured in grams/h. The particle size determination was determined by means of a Mastersizer 2000 from Malvern; measuring range 0.02-2000 μm by laser diffraction. The samples were prepared with a Hydro 2000 S wet dispersing unit from Malvern.

For comparison, the noninventive polyethylenes from examples 2-4 and 9 were ground under analogous conditions.

As further noninventive comparatives, the waxy polyethylenes GW 115.92.HV and GW 105.95.LV from GreenMantra, produced by thermal degradation of LLDPE and HDPE, respectively, and also a LICOWAX® PE 130 HDPE produced by Ziegler-Natta polymerization, from Clariant, and the two Fischer-Tropsch paraffins SASOLWAX® C80 and SASOLWAX® H1 from Sasol were ground and tested for throughput.

The physical data for the waxes are listed in table 1. The micronization results are contrasted in table 2. They show that with the polyethylenes from examples 5-8 it was possible to obtain micronized waxes with a particle size d₅₀ of at least comparable fineness, but with significantly higher throughput.

TABLE 1
Physical properties of the example waxes used:

| | | | | | | Ram | |
|---|---|---|---|---|---|---|---|
| | | Viscosity | Dropping | Melting | Heat of | penetration | |
| | | @ 140° C. | point | point | fusion | hardness | Density |
| Example | Designation | mPas | ° C. | ° C. | J/g | bar | g/cm³ |
| 1 comp. | Licowax ® PE 130 | 350 | 129 | 127 | 229 | 611 | 0.97 |
| 2 comp. | metallocene-PE wax | 350 | 130 | 127 | 264 | 550 | 0.97 |
| 3 comp. | metallocene-PE wax | 100 | 128 | 125 | 254 | 481 | 0.97 |
| 4 comp. | metallocene-PE wax | 60 | 128 | 123 | 268 | 470 | 0.97 |
| 5 inven. | metallocene-PE wax | 30 | 125 | 121 | 250 | 456 | 0.97 |
| 6 inven. | metallocene-PE wax | 14 | 122 | 116 | 248 | 409 | 0.96 |
| 7 inven. | metallocene-PE wax | 9 | 116 | 112 | 237 | 366 | 0.95 |
| 8 inven. | metallocene-PE wax | 8 | 115 | 111 | 225 | 346 | 0.95 |
| 9 comp. | metallocene-PE wax | 4 | 113 | 98 | 223 | 221 | 0.93 |
| 10 comp. | Sasolwax ® C80 | 4 | 88 | 82 | 222 | 268 | 0.92 |
| 11 comp. | Sasolwax ® H1 | 9 | 111 | 108 | 233 | 478 | 0.94 |
| 12 comp. | GW 115.92.HV | 482 | 115 | 111 | 150 | | 0.92 |
| 13 comp. | GW 105.95.LV | 38 | 106 | 108 | 132 | | 0.95 |

TABLE 2
Grinding results

| Wax | Through- | | |
|---|---|---|---|
| corresponding | put | d₅₀ | |
| to Tab. 1: | g/h | μm | Remarks |
| Example 1 | 1000 | 8.3 | trouble-free grinding |
| Example 2 | 1100 | 8.7 | trouble-free grinding |
| Example 3 | 1200 | 9.1 | trouble-free grinding |
| Example 4 | 1280 | 9.1 | trouble-free grinding |
| Example 5 (inv.) | 1511 | 8.3 | trouble-free grinding |
| Example 6 (inv.) | 1900 | 8.3 | trouble-free grinding |
| Example 7 (inv.) | 1920 | 8.5 | trouble-free grinding |
| Example 8 (inv.) | 1580 | 8.7 | trouble-free grinding |
| Example 9 | 950 | 9.3 | caking in grinding chamber |
| Example 10 | 950 | 8.9 | trouble-free grinding |
| Example 11 | 1240 | 8.5 | trouble-free grinding |
| Example 12 | 190 | 14.4 | severe caking in grinding chamber |
| Example 13 | 110 | 14.7 | severe caking in grinding chamber |

### Examples 14-16 (Use in Printing Ink Formulations)

The inventive micronized wax from example 7 was dispersed into the respective printing ink system and performance-tested in different printing technologies:

### Example 14: Flexographic Printing

The micronized wax was dispersed with a fraction of 0.5% and 0.8% into an aqueous flexographic ink, with intensive stirring using a dissolver, and was tested to standard. Used as comparative examples were two micronized waxes typical for the application, the product Spray 30 from Sasol (Fischer-Tropsch paraffin, d₅₀=6 μm) and Ceridust® 3610 from Clariant (micronized polyethylene wax, d₅₀=5.5 μm).

For the production of the ink, mixtures were prepared of Flexonyl Blue A B2G (Clariant) and distilled water (5:1; mixture A) and also from Viacryl SC 175 W, 40 WAIP (Cytec Ind.) and distilled water (1:1; mixture B). Then 70 parts of mixture B were stirred slowly into 30 parts of mixture A and the resulting mixture was homogenized at a stirring speed of 1200 rpm for 30 minutes. 0.5 or 0.8 wt %, respectively, of micronized wax was incorporated into the ink. The flexographic ink was applied to absorbent flexopaper with a film-drawing apparatus (Control Coater), using a wire doctor (LWC 60 g/m²; 6 μm wet film thickness).

After a drying time of 24 hours, measurements were made of scuff protection, gloss, and sliding friction.

For the determination of the scuff resistance, the print was first of all scuffed (Prüfbau Quartant scuff tester, scuffing load 48 g/cm², scuffing speed 15 cm/s). Measurements were made of the intensity of the ink transferred to the test sheet (color difference ΔE to DIN 6174, measurement with Hunterlab D 25-2, Hunter).

The coefficient of sliding friction was determined using a Friction Peel Tester 225-1 (Thwing-Albert Instruments).

The gloss was determined using a micro-TRI-gloss-μ gloss meter (BYK Gardner GmbH). The results set out in table 3 below show that the inventive wax is in no way inferior to the comparative examples in terms of color difference, and hence abrasion resistance, and also gloss and sliding friction.

TABLE 3
Aqueous flexographic printing on Algro Finess paper 80 g/m²

| | |
|---|---|
| Gloss | Sliding |

| Sample | 20° | 60° | friction | ΔE |
|---|---|---|---|---|
| no wax | 5 | 38 | 0.44 | 4.01 |
| 0.5% Spray 30 | 5 | 37 | 0.16 | 2.32 |
| 0.8% Spray 30 | 5 | 34 | 0.15 | 1.96 |
| 0.5% Ceridust 3610 | 5 | 36 | 0.19 | 2.83 |
| 0.8% Ceridust 3610 | 5 | 34 | 0.18 | 2.80 |
| 0.5% micronized | 5 | 37 | 0.17 | 2.78 |
| polyethylene from example 7 | | | | |
| 0.8% micronized | 5 | 35 | 0.17 | 2.77 |
| polyethylene from example 7 | | | | |

### Example 15: Gravure Ink

The micronized wax was dispersed into gravure ink with a fraction of 1%, with intensive stirring using a dissolver, and was tested to standard. Used as comparative examples were two micronized waxes typical for the application, the product Spray 30 from Sasol (d₅₀=6 μm) and Ceridust 3610 from Clariant (d₅₀=5.5 μm).

The ink employed was an illustration gravure ink RR Grav Red, toluene-based (Siegwerk Druckfarben AG); for the sample prints on gravure paper (Algro Finess 80 g/m²), an LTG 20 gravure machine from Einlehner Prüfmaschinenbau was used.

Measurements were made of scuff resistance, coefficient of sliding friction, and gloss. The results set out in table 4 below show that the inventive wax is in no way inferior to the comparative examples with regard to color difference and hence abrasion resistance and also gloss and sliding friction.

TABLE 4
Gravure printing

| | |
|---|---|
| Gloss | Sliding |

| Sample | 20° | 60° | friction | ΔE |
|---|---|---|---|---|
| Gravure ink - no wax, halftone | 13 | 62 | 0.61 | 14.8 |
| Gravure ink - no wax, | 26 | 80 | 0.59 | 13.3 |
| masstone | | | | |
| Gravure ink - Ceridust 3610, | 10 | 51 | 0.19 | 3.4 |
| halftone | | | | |
| Gravure ink - Ceridust 3610, | 18 | 63 | 0.19 | 3.3 |
| masstone | | | | |
| Gravure ink - micronized | 9 | 51 | 0.18 | 3.4 |
| polyethylene from example 7, | | | | |
| halftone | | | | |
| Gravure ink - micronized | 18 | 64 | 0.16 | 3.5 |
| polyethylene from example 7, | | | | |
| masstone | | | | |
| Gravure ink - Spray 30, | 9 | 49 | 0.16 | 3.2 |
| halftone | | | | |
| Gravure ink - Spray 30, | 17 | 60 | 0.16 | 3.5 |
| masstone | | | | |

### Example 16: Offset Ink

The micronized wax was dispersed into offset ink (Novaboard cyan 4 C 86, K+E Druckfarben) with a fraction of 1.5% and 3%, with intensive stirring using a dissolver, and was tested to standard. Used as comparative examples were two micronized waxes typical for the application, the product Spray 30 from Sasol (d₅₀=6 μm) and Ceridust 3610 from Clariant (d₅₀=5.5 μm).

A sample print (Prüfbau-Mehrzweck-Probedruckmaschine System Dr. Düner) was made on paper of type Phoenomatt 115 g/m² (Scheufelen GmbH+Co KG) and investigation was made of the scuff behavior on a scuff tester (Prüfbau Quartant scuff tester) for a scuffing load of 48 g/cm² and a scuffing speed of 15 cm/sec. Assessment was made of the intensity of the ink transferred to the test sheet (color difference to DIN 6174, measurement with Hunterlab D 25-2, Hunter). The results set out in table 5 below show that the inventive wax is in no way inferior to the comparative examples in terms of color difference and therefore abrasion resistance, and also gloss and sliding friction.

TABLE 5
Offset printing on paper

| | |
|---|---|
| Gloss | Sliding |

| Sample | 20° | 60° | friction | ΔE |
|---|---|---|---|---|
| no wax | 8 | 46 | 0.61 | 10.08 |
| 1.5% Spray 30 | 8 | 48 | 0.44 | 5.24 |
| 3.0% Spray 30 | 7 | 45 | 0.35 | 2.26 |
| 1.5% Ceridust 3610 | 9 | 52 | 0.49 | 4.07 |
| 3.0% Ceridust 3610 | 9 | 49 | 0.37 | 2.80 |
| 1.5% micronized | 10 | 53 | 0.40 | 3.73 |
| polyethylene from example 7 | | | | |
| 3.0% micronized | 9 | 50 | 0.31 | 2.64 |
| polyethylene from example 7 | | | | |

1. A polyethylene homopolymer, prepared with a metallocene catalyst system and having a melt viscosity as measured to DIN 53019 in the range from 5 to <60 mPa·s at 140° C. and by a ram penetration hardness as measured to DGF M-III 9e of 210 to 500 bar.

2. The polyethylene homopolymer as claimed in claim 1, having
a dropping point of 113 to 128° C.,
a melting point of 100 to 123° C.,
a density of 0.93 to 0.97 g/cm³ at 25° C.,
a heat of fusion of 210 to 270 J/g.

3. The polyethylene homopolymer as claimed in claim 1, having an average particle size d₅₀ of ≤15 μm.

4. The polyethylene homopolymer as claimed in claim 1, having an oxygen-containing group content and an acid number resulting therefrom in the range from 0.5 to 100 mg KOH/g.

5. A micronized wax having an average particle size d₅₀ of ≤15 μm, comprising a polyethylene homopolymer having a melt viscosity of 5 to <60 mPa·s at 140° C.

6. An additive component for printing inks comprising a polyethylene homopolymer as claimed in claim 1.

7. An additive component for coating materials comprising a polyethylene homopolymer as claimed in claim 1.

8. A component of hotmelt adhesives comprising a polyethylene homopolymer as claimed in claim 1.

9. A component of photographic toners comprising a polyethylene homopolymer as claimed in claim 1.

10. A component of pigment masterbatches comprising a polyethylene homopolymer as claimed in claim 1.

11. An additive component for printing inks comprising a micronized wax as claimed in claim 5.

12. An additive component for coating materials comprising a micronized wax as claimed in claim 5.

13. A component of hotmelt adhesives comprising a micronized wax as claimed in claim 5.

14. A component of photographic toners comprising a micronized wax as claimed in claim 5.

15. A component of pigment masterbatches comprising a micronized wax as claimed in claim 5.
